(19) United States
(12) Patent Application Publication
(10) Pub. No.: US 2009/0296170 A1
(43) Pub. Date: Dec. 3, 2009

(54) DRAWING DEVICE AND DRAWING METHOD

(75) Inventor: Katsuto Sumi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/917,369

(22) PCT Filed: May 25, 2006
(86) PCT No.: PCT/JP2006/310434

§ 371 Date: Dec. 13, 2007

(30) Foreign Application Priority Data
Jun. 16, 2005 (JP) 2005-176660

(51) Int. Cl. H04N 1/04

(52) U.S. Cl. 358/494

(57) ABSTRACT

An image is highly accurately drawn by correcting an error due to waving or defective optical characteristics of a photosensitive material and by preventing an appearance of irregularity in the drawing caused by a defect in micromirrors. To achieve this, a part of the micromirrors constructing a DMD is adapted to serve as a use region and the remaining part as a non-use region, pixels are formed on a photosensitive material with the width of the DMD set narrower relative to a scan direction, and multiplex exposure using the micro mirrors is performed to form each of the pixels.

### TECHNICAL FIELD

The present invention relates to a recording apparatus (drawing device) and a recording method (drawing method) for relatively moving a recording head having a plurality of recording elements arranged in a two-dimensional array in a predetermined scanning direction over a recording surface, and for controlling the recording elements according to recording data to record an image on the recording surface.

### BACKGROUND ART

Heretofore, there have been proposed various exposure apparatus, as an example of a recording apparatus, having a spatial light modulator such as a digital micromirror device (DMD) or the like for performing image exposure with a light beam modulated with image data. The DMD is a mirror device comprising a number of micromirrors therein for changing the angles of reflecting surfaces depending on control signals, the micromirrors being arranged in a two-dimensional array on a semiconductor substrate formed of silicon or the like. An exposure head formed with such a DMD therein is moved relatively in a scanning direction along an exposure surface in order to record a high-resolution image quickly within a desired range over the exposure surface (see Japanese Laid-Open Patent Publication No. 2004-62155).

The micromirrors of the DMD are usually arranged in rows and columns that extend perpendicularly to each other. The DMD is disposed obliquely to the scanning direction in order to keep scanning lines spaced closely to each other for enabling higher resolution.

### DISCLOSURE OF THE INVENTION

If the number of micromirrors is increased, so as to increase the area of the DMD, then an image having a wide area can efficiently be recorded. However, if the area of the DMD is increased, then it becomes extremely difficult to maintain a constant distance between the array surface of the micromirrors and the exposure surface on which the image is recorded, regardless of the positions of the micromirrors. For example, if the exposure surface is an undulating surface, then since the distance between the array surface varies depending on the exposure position, the amount of light and the beam diameter of the light beam applied to the exposure surface become irregular, tending to lower the accuracy of the recorded image.

One solution would be to reduce the width of the DMD in the scanning direction and to adjust the distance between the DMD and the exposure surface depending on the position in the scanning direction, for correcting an error caused by undulations of the exposure surface in the scanning direction.

However, if the width of the DMD in the scanning direction is reduced, then the number of micromirrors arrayed in the scanning direction also becomes reduced. In this case, the existence of defects and positional misalignments, etc., of the micromirrors is likely to make interval irregularities visually recognizable easily between pixels that are recorded in a direction perpendicular to the scanning direction. Such interval irregularities appear as striped irregularities in the scanning direction within the recorded two-dimensional image.

If an image is to be recorded using a number of micromirrors, on the assumption that the distance between the array surface of the micromirrors and the exposure surface is set highly accurately, then since the image data cannot be reset until the supply of image data to all of the micromirrors involved in recording the image has been completed, the light beam is continuously applied to the exposure surface in the meantime. As a result, pixels formed by the light beam become elongated in the direction in which the exposure surface is relatively moved, so that an edge of the image in the scanning direction, in particular, cannot be formed well.

It is a general object of the present invention to provide a recording apparatus and a recording method, which avoids the generation of recording irregularities caused by the positional relationship between a recording head and a recording surface, and recording characteristics of the recording head, etc., and for recording images highly accurately. A major object of the present invention is to provide a recording apparatus and a recording method for reducing the appearance of striped irregularities in a scanning direction.

Another object of the present invention is to provide a recording apparatus and a recording method for properly forming an edge of an image in a scanning direction.

### BRIEF DESCRIPTION OF THE DRAWINGS

FIG. 1 is a perspective view showing the appearance of an exposure apparatus, as an embodiment of a recording apparatus according to the present invention;

FIG. 2 is a perspective view of a scanner of the exposure apparatus;

FIG. 3A is a plan view showing exposed regions formed on an exposure surface of a photosensitive material;

FIG. 3B is a plan view showing an array of exposure areas of respective exposure heads;

FIG. 4 is a perspective view showing a general structure of an exposure head of the exposure apparatus;

FIG. 5A is a plan view showing a detailed structure of the exposure head of the exposure apparatus;

FIG. 5B is a side elevational view showing a detailed structure of the exposure head of the exposure apparatus;

FIG. 6 is an enlarged partial view showing a structure of a DMD of the exposure apparatus;

FIG. 7A is a perspective view illustrating the manner in which the DMD operates in an on-state;

FIG. 7B is a perspective view illustrating the manner in which the DMD operates in an off-state;

FIG. 8 is a perspective view showing a structure of a fiber array light source;

FIG. 9 is a front elevational view showing an array of light-emitting spots of a laser light emission unit of the fiber array light source;

FIG. 10 is a block diagram of a control circuit of the exposure apparatus shown in FIG. 1;

FIG. 11 is a view showing the relationship between a used region set on the DMD and an undulating recording surface;

FIG. 12 is a view showing the relationship between the used region set on the DMD and an optical system;

FIG. 13 is a view showing pixel shapes recorded on the recording surface when all of the micromirrors of the DMD are used;

FIG. 14 is a view showing pixel shapes recorded on the recording surface when some of the micromirrors of the DMD are used, and when a resetting time for image data is set according to the number of used micromirrors;

FIG. 15 is a diagram illustrating the manner in which individual recording spots are formed by respective micromirrors of the DMD;

FIG. 16 is a diagram illustrating the manner in which pixels are recorded in a multiple fashion by a plurality of micromirrors of the DMD;

FIG. 17 is a diagram showing an example of irregularities produced in a pattern on an exposure surface, upon occurrence of an exposure head mounting angle error and a pattern distortion;

FIG. 18 is a plan view showing the positional relationship between an exposure area of a single DMD and a corresponding slit;

FIG. 19 is a plan view illustrating a process of measuring the position of a light spot on an exposure surface using a slit;

FIG. 20 is a diagram showing the manner in which only selected used pixels are activated, in order to improve irregularities produced in a pattern on an exposure surface;

FIG. 21A is a diagram showing an example of a pattern distortion;

FIG. 21B is a diagram showing an example of another pattern distortion;

FIG. 22A is a diagram showing a first example of a reference exposure mode;

FIG. 22B is a diagram showing a first example of a main exposure mode;

FIG. 23A is a diagram showing a second example of a reference exposure mode; and

FIG. 23B is a diagram showing a second example of a main exposure mode.

### BEST MODE FOR CARRYING OUT THE INVENTION

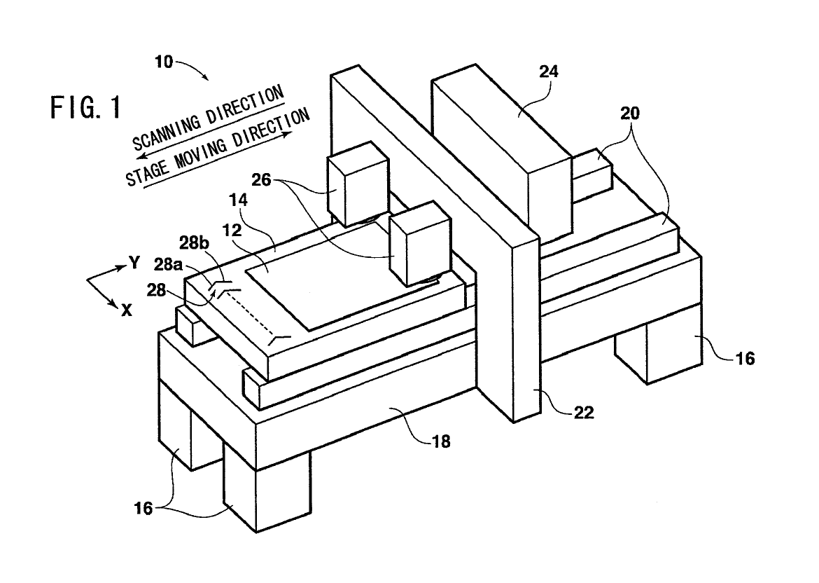

As shown in FIG. 1, an exposure apparatus 10 according to an embodiment of the present invention has a flat movable stage 14 for attracting and holding a sheet-like photosensitive medium 12 onto a surface thereof. Two guides 20 extending along a direction in which the movable stage 14 is movable are mounted on an upper surface of a mount base 18, in the form of a thick plate supported on four legs 16. The movable stage 14 is disposed such that the longitudinal direction thereof is oriented along the stage moving direction, and is supported reciprocally movably on the guides 20. The exposure apparatus 10 has a stage actuating unit (not shown), serving as a moving means for actuating the movable stage 14 along the guides 20.

A C-shaped gate 22 is mounted centrally on the mount base 18 across and over the path along which the movable stage 14 moves. The C-shaped gate 22 has ends thereof fixed respectively to both sides of the mount base 18. A scanner 24 is mounted on one side of the gate 22, and a plurality of (e.g., two) sensors 26 are mounted on the other side of the gate 22, for detecting a position of the photosensitive medium 12 as well as the distance to the photosensitive medium 12. The scanner 24 and the sensors 26 are attached to the gate 22 so as to be fixed above the moving path of the movable stage 14. The scanner 24 and the sensors 26 are connected to a control circuit, to be described later. For illustrative purposes, the X and Y directions that extend perpendicularly to each other are established within a plane parallel to the surface of the movable stage 14, as shown in FIG. 1.

Ten slits 28, each being chevron-shaped and opening in the X direction, are defined at equal intervals on an upstream end portion of the movable stage 14 along the scanning direction thereof. Each of the slits 28 comprises a slit 28a positioned upstream, and a slit 28b positioned downstream. The slit 28a and the slit 28b extend perpendicularly to each other. The slit 28a is inclined −45 degrees to the X direction, and the slit 28b is inclined +45 degrees to the X direction. Light detectors, to be described later, each of a single cell type, are disposed at positions below the slits 28 on the movable stage 14.

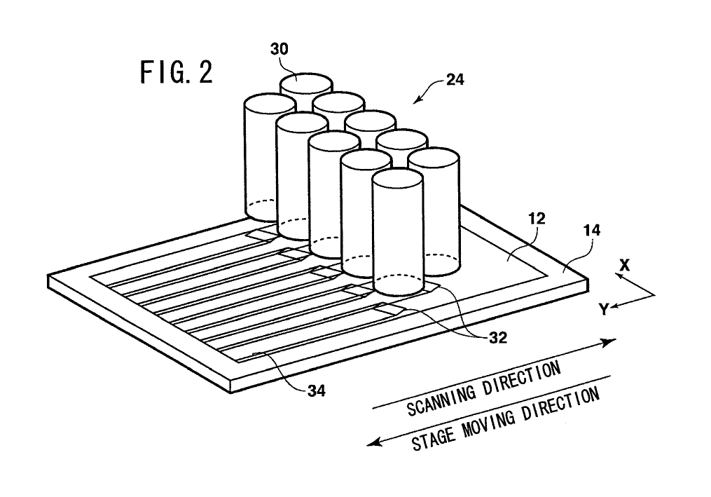

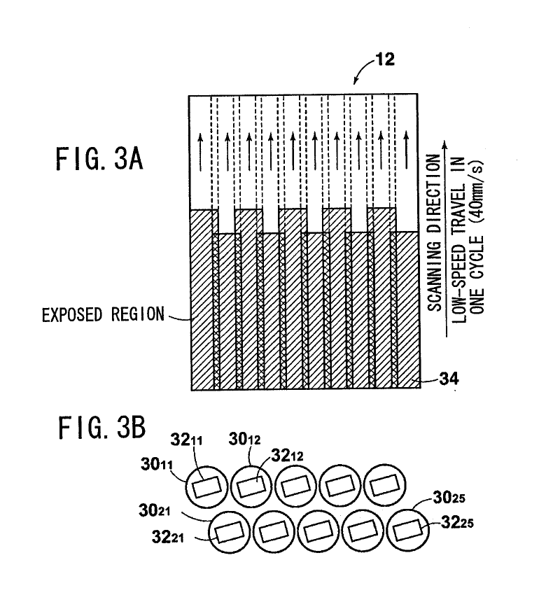

As shown in FIGS. 2 and 3B, the scanner 24 comprises ten exposure heads 30 arranged substantially as a matrix made up of two rows and five columns. An individual exposure head, located in an mth row and an nth column, shall be referred to as an exposure head 30ₘₙ.

Each of the exposure heads 30 is mounted in the scanner 24 such that the columns of pixels of a digital micromirror device (DMD) 36 disposed therein, to be described later, are inclined to the X direction by a predetermined set tilt angle θ. An exposure area 32 of each of the exposure heads 30 forms a rectangular area inclined to the scanning direction. As the movable stage 14 moves, web-shaped exposed regions 34 are formed on the photosensitive medium 12 by the respective exposure heads 30. An exposure area of an exposure head, which is disposed in an mth row and an nth column, shall be referred to as an exposure area 32ₘₙ.

As shown in FIGS. 3A and 3B, the exposure heads 30 within respective rows arranged in lines are staggered by predetermined intervals (multiplied by a natural number of a longer side of the exposure areas, twice in the present embodiment), such that each of the web-shaped exposed regions 34 overlaps an adjacent web-shaped exposed region 34. Therefore, a portion of the photosensitive medium 12, which is not exposed between an exposure area 321, and an exposure area 32₁₂ in the first row, is exposed by an exposure area 32₂₁ in the second row.

The exposure heads 30 have respective central positions substantially aligned with respective positions of the ten slits 28. The size of each of the slits 28 is large enough so as to cover the width of the exposure area 32 of the corresponding exposure head 30.

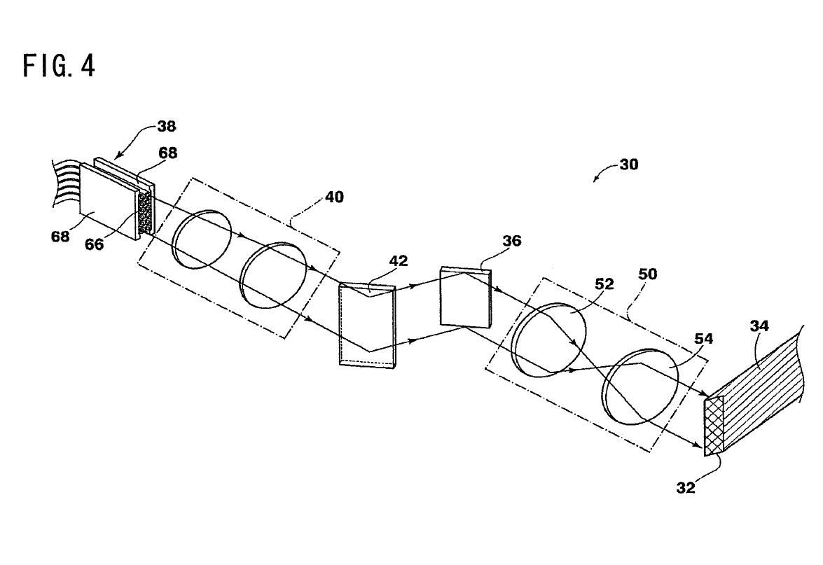

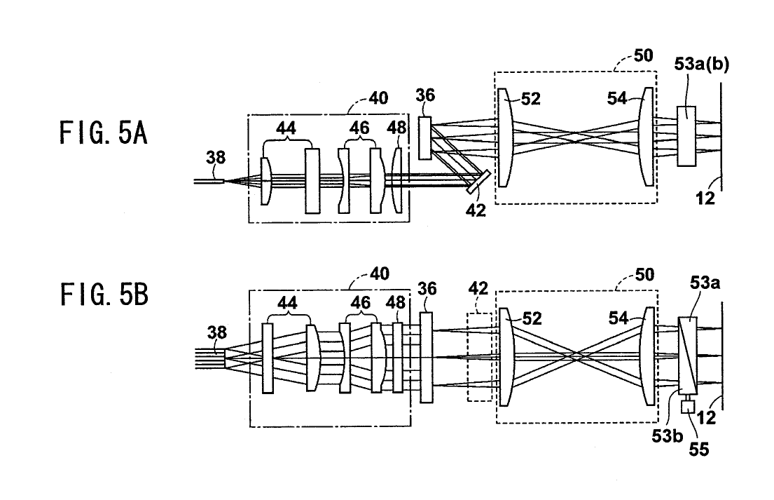

As shown in FIGS. 4, 5A and 5B, each of the exposure heads 30 includes a DMD 36, manufactured by Texas Instruments, U.S.A., which serves as a spatial light modulator for modulating applied light depending on image data. The DMD 36 is connected to a DMD modulator, described later, comprising a data processor and a mirror actuation controller. The data processor of the DMD modulator generates a control signal for controlling actuation of each of the micromirrors within an employed region of the DMD 36 of each exposure head 30. The mirror actuation controller controls angles of the reflecting surfaces of the micromirrors of the DMD of each exposure head 30, based on control signals generated by the image data processor.

As shown in FIG. 4, on the light entrance side of the DMD 36, there are disposed a fiber array light source 38 comprising a laser emitter having optical fiber emission ends (light emission spots) that are arranged in an array along a direction aligned with the longitudinal direction of the exposure area 32, a lens system 40 for focusing laser beams emitted from the fiber array light source 38 onto the DMD 36, and a mirror 42 for reflecting the laser beams that have passed through the lens system 40 toward the DMD 36, these elements being arranged successively in the order named. The lens system 40 is illustrated in outline in FIG. 4.

As shown in detail in FIGS. 5A and 5B, the lens system 40 comprises a pair of combined lenses 44 for converting laser beams emitted from the fiber array light source 38 into parallel laser beams, a pair of combined lenses 46 for correcting the parallel laser beams such that the amounts of light of the fiber array light source 38 have a uniform distribution, and a condensing lens 48 for converging the laser beams, which have been corrected with respect to the distribution of the amounts of light, onto the DMD 36.

On the light reflection side of the DMD 36, a lens system 50 is provided for focusing the laser beams reflected by the DMD 36 onto an exposure surface of the photosensitive medium 12. The lens system 50 comprises two lenses 52 and 54, disposed such that the DMD 36 and the exposure surface of the photosensitive medium 12 are in a conjugate relation to each other.

According to the present embodiment, laser beams emitted from the fiber array light source 38 are enlarged substantially five times, and thereafter light beams from the respective micromirrors of the DMD 36 are constricted to about 5 μm by the lens system 50.

A pair of wedge-shaped prisms 53a, 53b is disposed between the lens system 50 and the photosensitive medium 12. One of the wedge-shaped prisms 53b is displaceable by a piezoelectric device 55 with respect to the other wedge-shaped prism 53a, in directions perpendicular to the optical axes of the laser beams. Focused positions of the laser beams on the photosensitive medium 12 can be adjusted by changing the relative positional relationship of the wedge-shaped prisms 53a, 53b by means of the piezoelectric device 55.

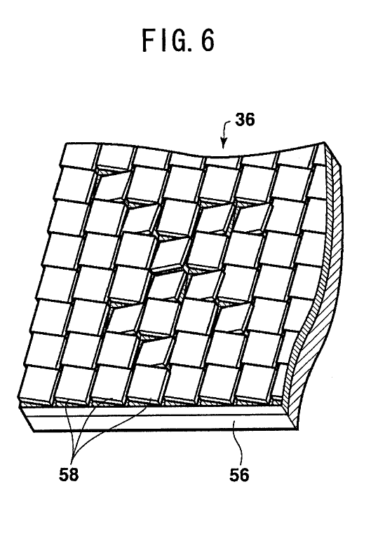

As shown in FIG. 6, the DMD 36 is a mirror device comprising a number of micromirrors 58 disposed on an SRAM cell (memory cell) 56, and arranged in a grid-like pattern so as to provide respective pixels. In the present embodiment, the micromirrors 58 making up the DMD 36 are arranged in 1024 columns×768 rows. Among those micromirrors 58, a usable region of micromirrors 58 is set by a mask data setting unit, to be described later, which is connected to the DMD modulator in order to modulate the DMD 36. Each of the micromirrors 58 is supported by supporting posts, and has a surface evaporated with a material that exhibits high reflectance, such as aluminum or the like. In the present embodiment, the reflectance of each of the micromirrors 58 is 90% or higher. The micromirrors 58 are spaced at vertical and horizontal pitches of 13.7 μm. The SRAM cell 56 is a silicon-gate CMOS type, fabricated on an ordinary semiconductor memory fabrication line through the support posts, which include hinges and yokes. The SRAM cell 56 forms a monolithic (integral) structure as a whole.

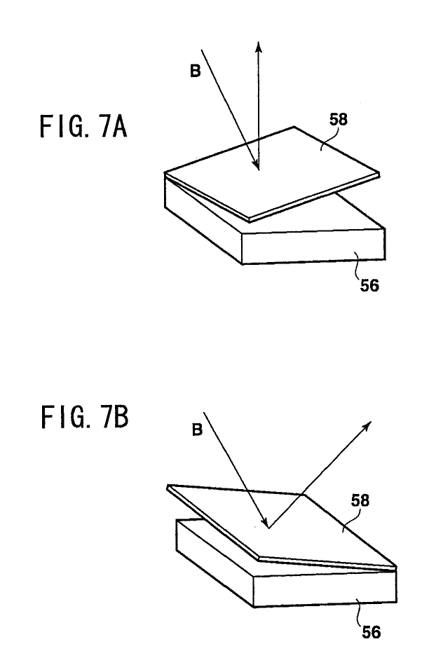

When an image signal representing a binary density level of each of the spots that make up a desired two-dimensional pattern is written in the SRAM cell 56 of the DMD 36, the micromirrors 58 supported by the support columns are inclined by either one of ±α degrees (e.g., ±10 degrees) about a diagonal line with respect to a board on which the DMD 36 is mounted. FIG. 7A shows an on-state in which a micromirror 58 is tilted +α degrees, and FIG. 7B shows an off-state in which a micromirror 58 is tilted—αdegrees. Therefore, when the tilt of the micromirror 58 at each pixel of the DMD 36 is controlled depending on image data as shown in FIG. 6, the laser beam B applied to the DMD 36 is reflected by the direction in which the micromirror 58 is tilted.

FIG. 6 shows a portion of the DMD 36 at an enlarged scale, with each micromirror 58 being controlled at +α degrees or −α degrees. The micromirrors 58 are turned on and off by the DMD modulator connected to the DMD 36. A light absorber (not shown) is disposed at an orientation in which the laser beams B travel, when reflected in an off-state by the micromirrors 58.

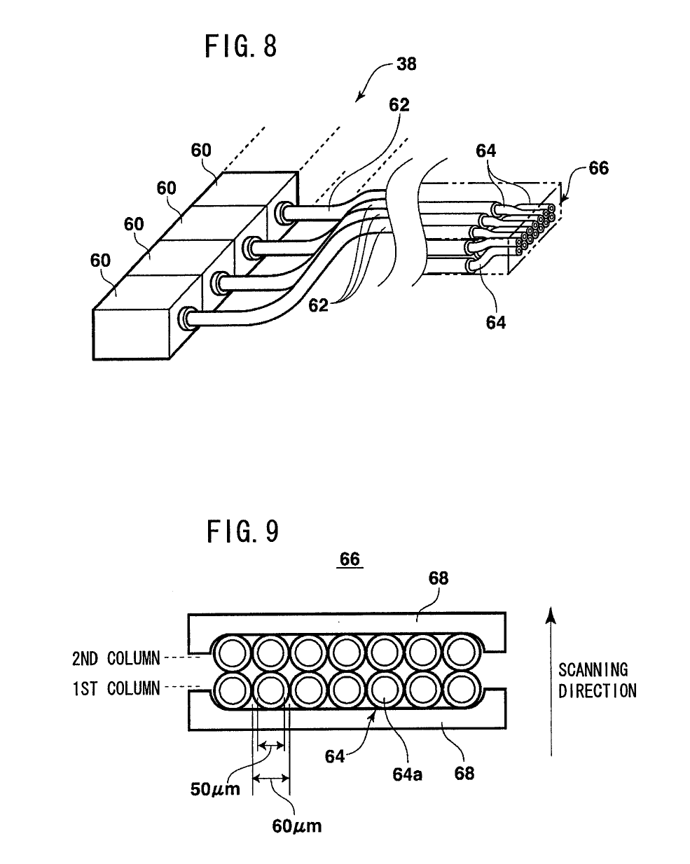

As shown in FIG. 8, the fiber array light source 38 comprises a plurality of (e.g., 14) laser modules 60 connected to respective ends of a plurality of multimode optical fibers 62. The multimode optical fibers 62 have respective other ends thereof connected to respective multimode optical fibers 64, having cladding diameters smaller than those of the multimode optical fibers 62. As shown in detail in FIG. 9, the multimode optical fibers 64 have respective ends, remote from the multimode optical fibers 62, and which are arranged in two rows, each including seven multimode optical fibers arrayed along a direction perpendicular to the scanning direction, thereby providing a laser emitter 66.

As shown in FIG. 9, the laser emitter 66, which is constructed from ends of the multimode optical fibers 64, is sandwiched in position by two support plates 68 having flat surfaces. A transparent protective plate of glass or the like preferably is disposed against the emitting end faces of the multimode optical fibers 64, for thereby protecting the emitting end faces. The emitting end faces of the multimode optical fibers 64 tend to collect dust particles and deteriorate quickly, because the light beam density at the emitting end faces is high. However, the protective plate, which is held against the emitting end faces, prevents dust particles from being deposited on the emitting end faces, and hence prevents the emitting end faces from becoming unduly deteriorated.

According to the present invention, the exposure apparatus 10 performs a double exposure process. In an ideal condition where the exposure heads 30 are free of mounting angle errors, then the set tilt angle θ of each of the exposure heads 30, i.e., each of the DMDs 36, is slightly greater than an angle θ_{ideal} at which the double exposure process can be performed by means of the usable micromirrors in 1024 columns×256 rows, wherein the angle θ_{ideal} is given according to:

s·p·sin θ_{ideal}=N·δ (1)

where N represents the number N of an N-multiple exposure process, s is the number of micromirrors 58 of each pixel row of the usable micromirrors 58, p is the pixel pitch in the direction of each pixel row of the usable micromirrors 58, and δ is the pixel row pitch of the usable micromirrors 58, along the direction perpendicular to the scanning direction.

Since the DMD 36 according to the present embodiment comprises a number of micromirrors 58, which are arranged in a rectangular grid-like pattern at equal vertical and horizontal pitches, the following equation is satisfied:

p·cos θ_{ideal}=δ (2)

Therefore, the above equation (1) can be expressed as follows:

s·tan θ_{ideal}=N (3)

Since s=256 and N=2 in the present embodiment, from equation (3), the angle θ_{ideal} is about 0.45 degrees. Accordingly, the set tilt angle θ may be an angle of about 0.50 degrees. It is assumed that the exposure apparatus 10 is initially adjusted so as to set the mount angle of each of the exposure heads 30, i.e., each of the DMDs 36, to an angle close to the set tilt angle θ within an adjustable range thereof.

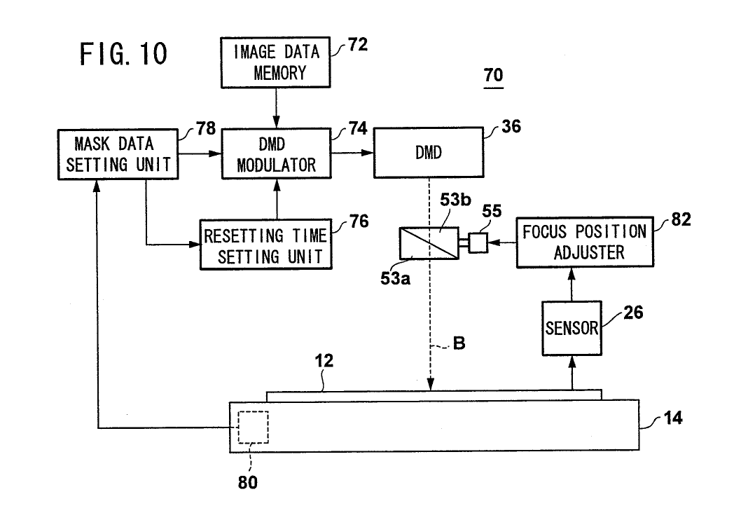

FIG. 10 is a block diagram showing an essential arrangement of a control circuit 70 of the exposure apparatus 10. The control circuit 70 comprises an image data memory 72 for storing image data of an image to be recorded on the photosensitive medium 12, and a DMD modulator 74 (recording element control means) for actuating the micromirrors 58 by modulating the DMD 36, based on image data read from the image data memory 72. The DMD modulator 74 resets the image data for actuating micromirrors 58 within a preset range, at a resetting time set by a resetting time setting unit 76, and thereafter modulates the DMD 36 with the image data, in a subsequent exposure cycle read from the image data memory 72.

The DMD modulator 74 is supplied with mask data, which is set by a mask data setting unit 78 (mask data setting means). The mask data are data for turning on and off only those micromirrors that are positioned within a given range, among the micromirrors 58 making up the DMD 36, according to image data, and wherein the remaining micromirrors 58 are turned off at all times. The mask data can be determined from the tilt angle of the DMD 36, which is calculated based on information of laser beams B, as detected by light detectors 80, emitted from the scanner 24 and applied through the slits 28 in the movable stage 14.

The control circuit 70 also includes a focus position adjuster 82 for energizing the piezoelectric device 55 based on information of the distance up to the photosensitive medium 12, as detected by the sensors 26, to focus the laser beams B onto the photosensitive medium 12.

The exposure apparatus 10 according to the present embodiment is basically constructed as described above. Operations and advantages of the exposure apparatus 10 shall be described below.

In the present embodiment, not all of the micromirrors 58 making up the DMD 36 are used for exposure recording, but rather, some of the micromirrors 58 are used to avoid effects caused by undulation of the photosensitive medium 12, in addition to optical characteristic defects of the scanner 24.

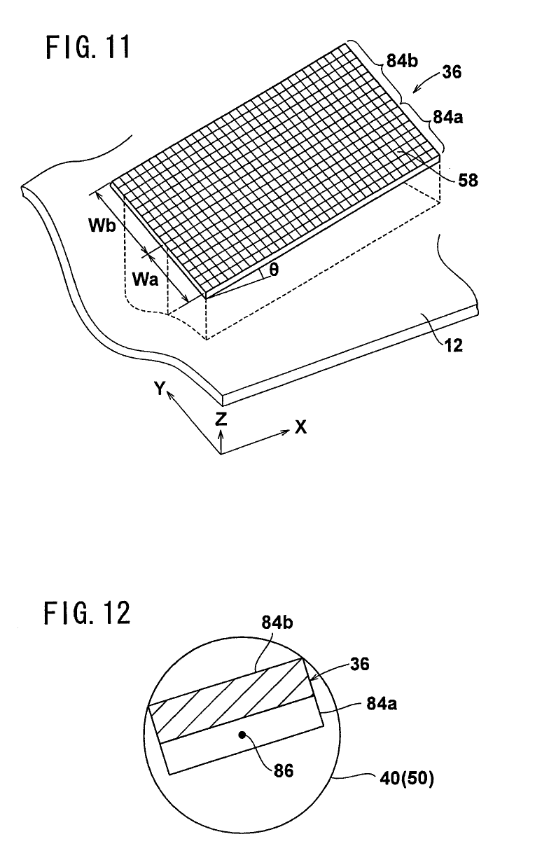

FIG. 11 is a view showing the layout relationship between the DMD 36 and the photosensitive medium 12. The micromirrors 58 making up the DMD 36, which are inclined at the set tilt angle θ to the X direction, are divided into a used region 84a (partial element region) having a width Wa that contributes to exposure, and an unused region 84b having a width Wb that does not contribute to exposure, substantially along the Y direction, which is the scanning direction of the scanner 24.

With the used region 84a of the micromirrors 58 being thus limited, if the photosensitive medium 12 does not have a uniform height in the Z direction, but rather undulates in the Z direction, as to the distances between the micromirrors 58 within the used region 84a and the photosensitive medium 12, the differences between the micromirrors 58 are smaller than when all of the micromirrors 58 making up the DMD 36 are used.

The distance between the DMD 36 and the photosensitive medium 12 at each of the positions along the Y direction is detected by the sensors 26, and the focus position adjuster 82 energizes the piezoelectric device 55 depending on the distance at each position, so as to positionally control the wedge-shaped prisms 53a, 53b for thereby adjusting the optical path length of the laser beam B, and to focus the laser beam B from each of the micromirrors 58 within the used region 84a highly accurately onto the photosensitive medium 12, irrespective of the position in the Y direction. This process is carried out on each of the exposure heads 30 so as to focus the laser beam B highly accurately onto the photosensitive medium 12, at each position in the X and Y directions.

Instead of adjusting the optical path length of the laser beam B with the wedge-shaped prisms 53a, 53b, each of the exposure heads 30 or the movable stage 14 may alternately be moved vertically, to thereby adjust the optical path length of the laser beam B according to the distance detected by the sensors 26.

As shown in FIG. 12, the used region 84a, which is set to have a reduced width in the Y direction, may be set about the optical axis 86 of the lens systems 40, 50 of the scanner 24, such that laser beams B having a desired beam spot shape are guided toward the photosensitive medium 12 through a central portion of the lens systems 40, 50, which suffers less aberration.

The used region 84a may be set using mask data, to be described later. The width Wa of the used region 84a should desirably be set to one-half or less than the width of the DMD 36 in the Y direction. This is because, even if the micromirrors 58 within the used region 84a fail to operate normally while the DMD 36 is used over a long period of time, the unused region 84b, the micromirrors 58 of which operate normally, can be used instead of the used region 84a in order to increase the service life of the DMD 36.

The aspect ratio (=the number of micromirrors 58 in the Y direction/the number of micromirrors 58 in the X direction) of the used region 84a of the DMD 36 should be set to one-half or less, or preferably one-quarter or less, or more preferably, one-tenth or less.

If the used region 84a is set as a portion of the DMD 36, a resetting time, for resetting the image data that is supplied to the DMD modulator 74, is set depending on the number of micromirrors 58 making up the used region 84b.

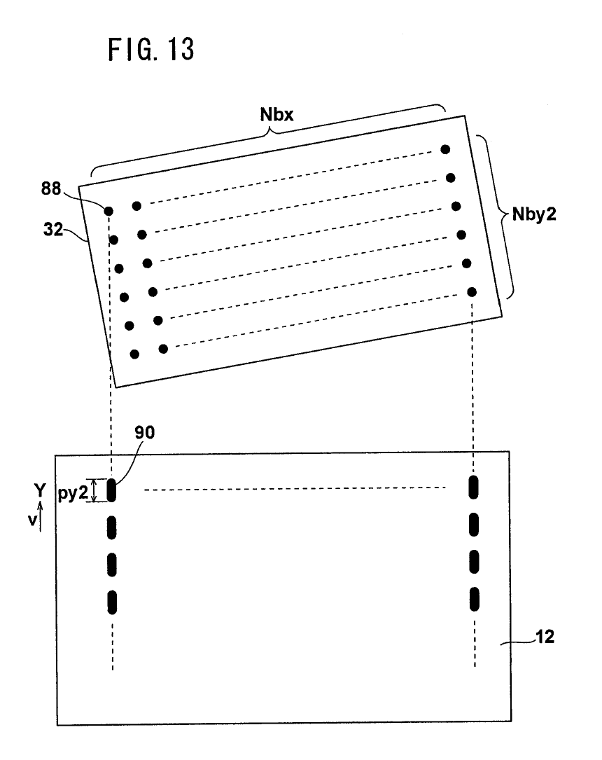

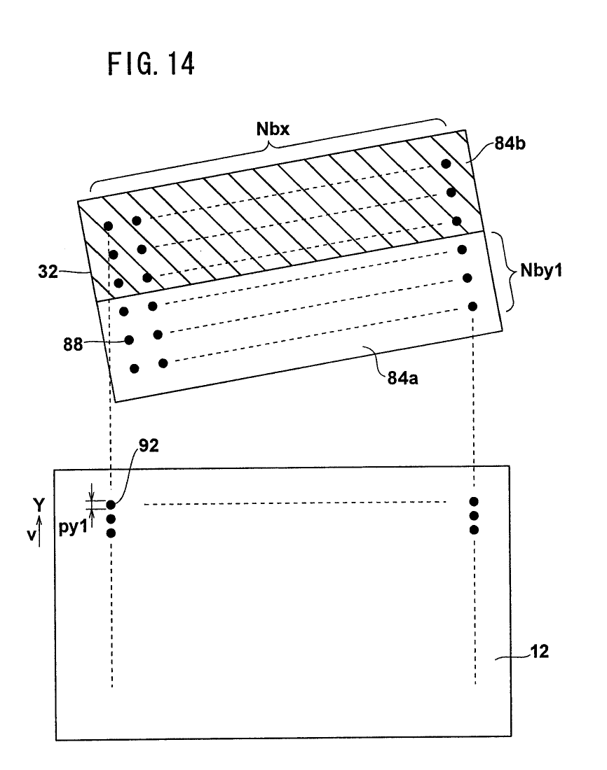

FIG. 13 is a view illustrative of the resetting time, assuming that all of the used region 84a and the unused region 84b of the DMD 36 are used. FIG. 14 is a view illustrative of the resetting time, assuming that only the used region 84a of the DMD 36 is used.

In FIG. 13, if the number in the direction of columns of light spots 88 of the exposure area 32 of all of the micromirrors 58 making up the DMD 36 is represented by Nbx, and the number in the direction of rows is represented by Nby2, then the number Nb2 of all of the micromirrors 58 used for exposure is given by:

Nb2=Nbx·Nby2 (4)

Therefore, after the Nb2 micromirrors 58 are actuated by Nb2 image data supplied to the DMD modulator 74, if the Nb2 image data are reset and new Nb2 image data are supplied to the DMD modulator 74, then the required resetting time t2 therefor is expressed by:

t2αNb2 (5)

At this time, assuming the scanning speed in the Y direction with respect to the photosensitive medium 12 is represented by v, then the width py2 of a pixel 90 in the Y direction, which is formed on the photosensitive medium 12 by each light spot 88, is given by:

py2=t2·v (6)

In FIG. 14, assuming the number in the direction of rows of micromirrors 58 of the used region 84a of the DMD 36 is represented by Nby1, then the number Nb1 of micromirrors 58 used for exposure is given by:

Nb1=Nbx·Nby1 (7)

In this case, a resetting time t1 for resetting Nb1 image data is expressed by:

t1αNb1 (8)

The width py1 of a pixel 92 in the Y direction, which is formed on the photosensitive medium 12 by each light spot 88 in the used region 84a, is given by:

py1=t1·v (9)

Since Nb1<Nb2, from equations (5) and (8), the resetting time t1 can be expressed as t1<t2. Therefore, by setting the used region 84a in the DMD 36 and the resetting time t1 in the DMD modulator 74, the width py1 of the pixel 92 can be made smaller than the width py2 of the pixel 90, in the case that all of the micromirrors 58 making up the DMD 36 are used. For example, if Nby2=2·Nby1, by setting the resetting time t1 to one-half the resetting time t2, the width py1 of the pixel 92 can be made one-half the width py2 of the pixel 90.

As described above, when a partial element region of the DMD 36 is set to the used region 84a, and the resetting time is set depending on the number of micromirrors 58 in the used region 84a, elongation of the pixel 90 within the Y direction, as shown in FIG. 13, can be improved (see FIG. 14).

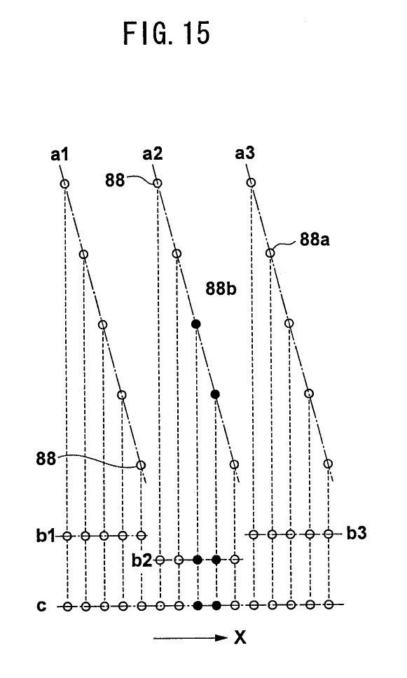

It cannot be guaranteed that all of the micromirrors 48 of the DMD 36 will operate normally at all times. For example, if defective micromirrors 58 are mixed in among normally operating micromirrors 58, then as shown in FIG. 15, light spots 88b (black dots) caused by the defective micromirrors 58 are formed among the light spots 88a (white dots) caused by the normal micromirrors 58. In this case, striped irregularities caused by the defective micromirrors 58 appear in the Y direction, which is the scanning direction of the photosensitive medium 12. In FIG. 15, lines b1 through b3 are shown as being formed in the X direction on the photosensitive medium 12, by lines a1 through a3 produced by the light spots 88a, 88b formed by the DMD 36 and arrayed in rows. Further, these lines b1 through b3 are shown as being combined into a line c.

As shown in FIG. 14, if the micromirrors 58 of the used region 84a, which is a partial element region of the DMD 36, are used to perform exposure recording, then the number of light spots 88 making up the lines a1 through a3 are reduced. Therefore, the set tilt angle θ of the DMD 36 must be set to a large value, in order to adjust the distance in the X direction between the light spot 88 at the lower end of the line a1 and the light spot 88 at the upper end of the line a2, as shown in FIG. 15, for example. As a result, the distance between the light spots 88 that make up the line c is increased, thereby allowing defects to be visually recognized easily. Particularly, if defective micromirrors 58 are present successively on one line (e.g., the line a2), then a striped irregularity appearing on the photosensitive medium 12 acquires a large width.

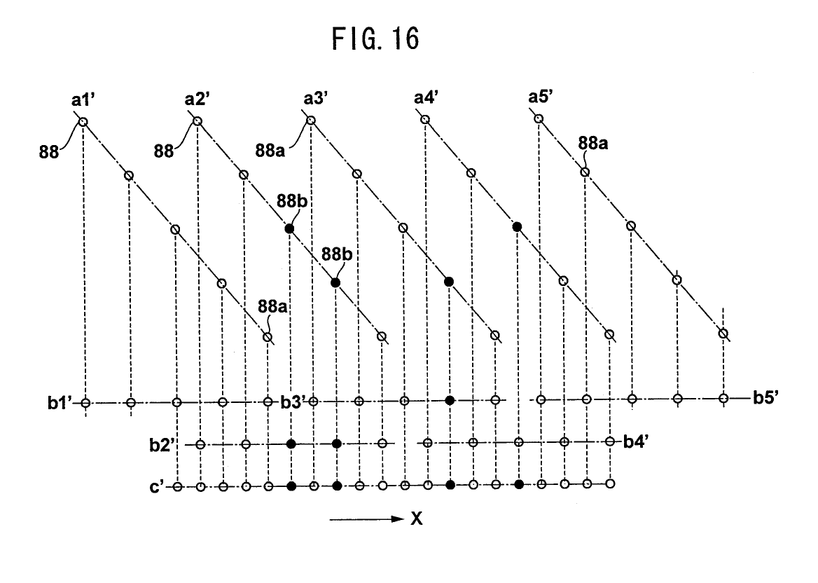

According to the present embodiment, as shown in FIG. 16, the set tilt angle θ of the DMD 36 is adjusted so as to form pixels at the same positions or nearby positions on one line c′, with a plurality of light spots 88 making up different lines a1′ through a5′. In this manner, a so-called multiple exposure process is carried out. FIG. 16 shows a double exposure process performed using the light spots 88 making up the lines a1′ through a5′.

If the set tilt angle θ is set to form pixels in near positions on the line c′ with normal light spots 88a on the line a3′ and defective light spots 88b on the adjacent line a2′, for example, then as shown in FIG. 16, the normal light spots 88a are inserted between the defective light spots 88b, thereby reducing irregularities due to the successive defective micromirrors 58. If the set tilt angle θ is set to form pixels in the same positions on the line c′ with normal light spots 88a on the line a3′ and defective light spots 88b on the adjacent line a2′, for example, then the normal light spots 88a compensate for the defective light spots 88b, thereby similarly reducing irregularities due to the successive defective micromirrors 58. As a result, in either case, the multiple exposure process reduces the appearance of striped irregularities due to the defective micromirrors 58.

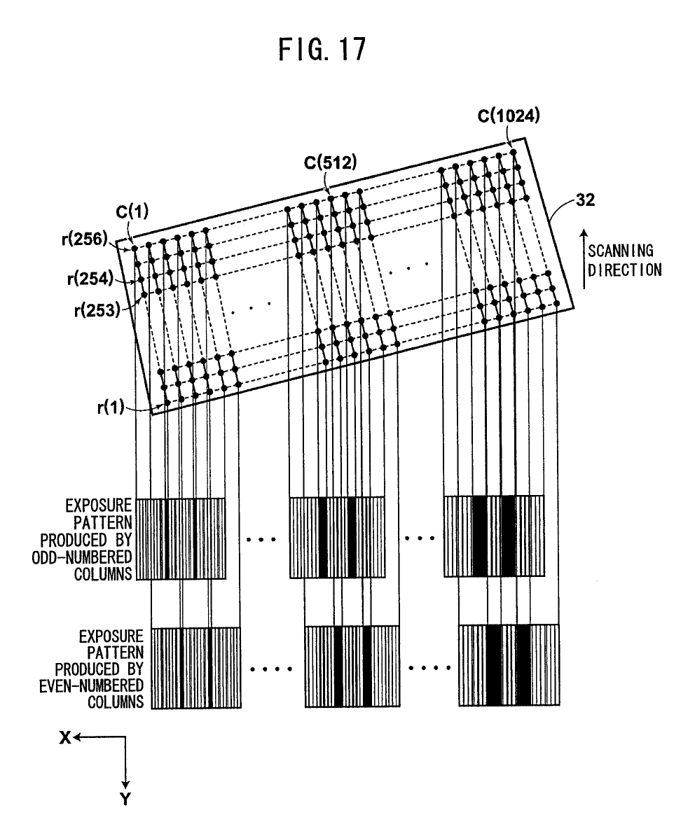

FIG. 17 is a diagram showing an example of irregularities produced in a pattern on the exposure surface, caused by a mounting angle error of one exposure head 30 and a pattern distortion in the exposure apparatus 10, wherein the used region 84a of the DMD 36 is initially adjusted as described above and the set tilt angle θ is adjusted initially for the multiple exposure process. In the figures and the description referred to below, it is assumed that an mth light spot row on the exposure surface is represented by r(m), an nth light spot column on the exposure surface is represented by c(n), and a light spot in the mth row and the nth column is represented by P(m,n). FIG. 17 shows, in an upper area thereof, a pattern of light spots from the micromirrors 58 of the used region 84a, which are projected onto the exposure surface of the photosensitive medium 12 while the movable stage 14 is at rest. FIG. 17 shows, in a lower area thereof, an exposed pattern formed on the exposure surface when the movable stage 14 is moved to perform a continuous exposure while the pattern of light spots shown in the upper area of FIG. 17 appears. In FIG. 17, an exposed pattern produced by odd-numbered columns of micromirrors 58 of the used region 84a, and an exposed pattern produced by even-numbered columns of micromirrors 58, are separately illustrated for the sake of convenience. The actual exposed pattern on the exposure surface is provided as a combination of these two exposed patterns, which are superimposed on one another.

In the example shown in FIG. 17, the actual mount angle is slightly different from the above set tilt angle θ because the set tilt angle θ is slightly greater than the angle θ_{ideal}, and also because the mount angle of the exposure head 30 is difficult to adjust finely. As a consequence, in both the exposed pattern produced by the odd-numbered columns and the exposed pattern produced by the even-numbered columns, exposure is more redundant than is possible with an ideal double exposure process, resulting in density irregularities at areas corresponding to the ends of the pixel columns, i.e., at junctions between the pixel columns, at locations on the exposure surface.

Furthermore, in the example shown in FIG. 17, an angle distortion develops, which is an example of a pattern distortion appearing on the exposure surface, representing irregular tilt angles of the pixel columns projected onto the exposure surface. Such an angle distortion is caused by various aberrations and misalignments of the optical system that occur between the DMD 36 and the exposure surface, as well as distortions of the DMD 36 itself and layout errors of the micromirrors 58, etc. According to the angle distortion appearing in the example shown in FIG. 17, the tilt angle with respect to the scanning direction is smaller for leftward pixel columns and greater for rightward pixel columns. Because of the angle distortion, the width of areas where the exposure is more redundant is smaller in the leftward areas and larger in the rightward areas on the exposure surface.

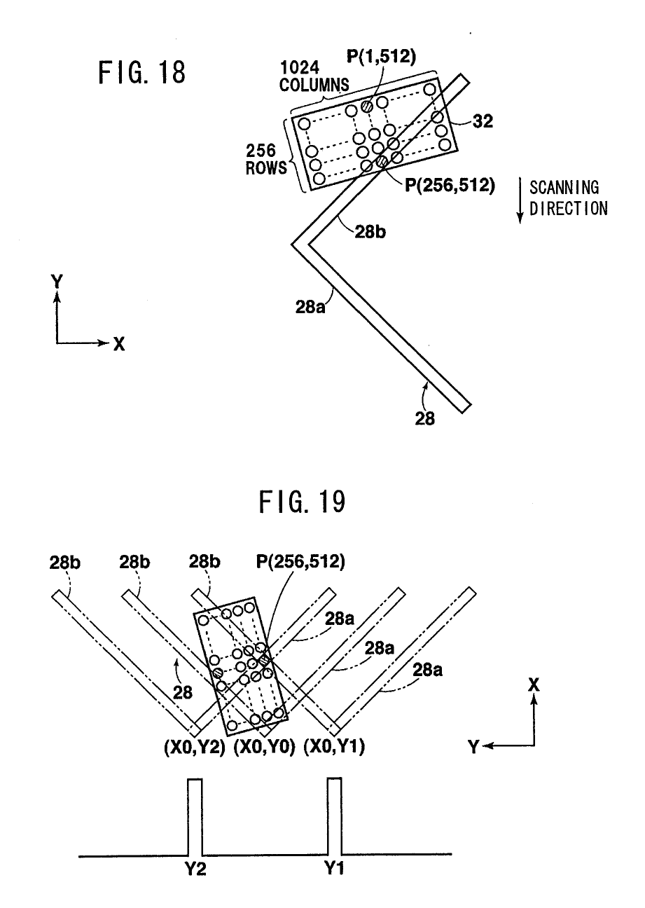

For reducing the above irregularities appearing on the exposure surface, according to the present embodiment, the set of slits 28 and the light detectors 80 identify an actual tilt angle θ′ of the pixel columns projected onto the exposure surface for each exposure head 30, and the mask data setting unit 78 connected to the light detectors 80 generates mask data for determining the used region 84a of the micromirrors 58, which is actually used for the main exposure mode, based on the actual tilt angle θ′. A process for identifying the actual tilt angle θ′ and generating the mask data shall be described below with reference to FIGS. 18 and 19.

FIG. 18 is a plan view showing the positional relationship between the exposure area 32 of a single DMD 36 and a corresponding slit 28. As described above, the size of the slit 28 is large enough to cover the width of the exposure area 32. According to the present embodiment, the angle formed between the direction of a representative light spot column, which is the 512th light spot column positioned substantially centrally within the exposure area 32, and the scanning direction is measured as the actual tilt angle θ′. Specifically, the micromirror 58 in the 512th column and the first row on the DMD 36 along with the micromirror 58 in the 512th column and the 256th row on the DMD 36 are turned on, and then the positions of corresponding light spots P(1, 512) and P(256, 512) on the exposure surface are detected, after which the tilt angle of a straight line interconnecting the light spots is identified as the actual tilt angle θ′.

FIG. 19 is a plan view illustrating a process for detecting the position of the light spot P(256, 512). First, while the light spot P(256, 512) is turned on, the movable stage 14 is slowly moved so as to relatively move the slit 28 along the Y direction, until the light spot P(256, 512) is positioned somewhere between the upstream slit 28a and the downstream slit 28b. At this time, the coordinates of the point of intersection between the slits 28a, 28b are represented by (X0, Y0). The values of the coordinates (X0, Y0) are determined from the distance that the movable stage 14 has moved to the above position, as indicated by a drive signal supplied to the movable stage 14, and the known position of the slit 28 in the X direction, and then the coordinate values are recorded.

Then, the movable stage 14 is moved so as to relatively move the slit 28 along the Y direction to the right in FIG. 19. The movable stage 14 is stopped when the light of the light spot P(256, 512) passes through the left slit 28b and is detected by the light detector, as indicated by the two-dot-and-dash lines in FIG. 19. At this time, the coordinates of the point of intersection between the slits 28a, 28b are recorded as (X0, Y1).

The movable stage 14 is then moved in the opposite direction, so as to relatively move the slit 28 along the Y direction to the left in FIG. 19. The movable stage 14 is stopped when the light of the light spot P(256, 512) passes through the right slit 28a and is detected by the light detector 80, as indicated by the two-dot-and-dash lines in FIG. 19. At this time, the coordinates of the point of intersection between the slits 28a, 28b are recorded as (X0, Y2).

Based on the above measurements, the coordinates (X, Y) of the light spot P(256, 512) are determined by calculating X=X0+(Y1−Y2)/2, Y=(Y1+Y2)/2. Similar measurements are also made in order to determine the coordinates of the light spot P(1, 512). The tilt angle of the straight line interconnecting the light spot P(256, 512) and the light spot P(1, 512) is derived and identified as the actual tilt angle θ′.

Using the actual tilt angle θ′ thus identified, the mask data setting unit 78 derives a natural number T, which is closest to a value t that satisfies the relationship:

t·tan θ′=T (10)

and generates mask data for selecting the micromirrors from the first row to the Tth row on the DMD 36, as the micromirrors 58 of the used region 84a which are actually used for the main exposure mode.

In this manner, micromirrors 58 which minimize the sum of areas where exposure is redundant compared with an ideal double exposure process, and which minimize areas where exposure is insufficient compared with the ideal double exposure process, can be selected as micromirrors 58 to be actually used within a representative region near the 512th light spot column.

Instead of deriving a natural number N that is closest to the value t, a minimum natural number N equal to or greater than the value t may be derived. In such a case, micromirrors 58 that minimize areas where exposure is redundant compared with the ideal double exposure process, and which eliminate areas where the exposure is insufficient compared with the ideal double exposure process, can be selected as the actually used micromirrors 58 within the representative region near to the 512th light spot column. Alternatively, a minimum natural number N equal to or smaller than the value t may be derived. In such a case, micromirrors 58 that minimize areas where exposure is insufficient compared with the ideal double exposure process, and which eliminate areas where the exposure is redundant compared with the ideal double exposure process, can be selected as the actually used micromirrors 58 within the representative region near to the 512th light spot column.

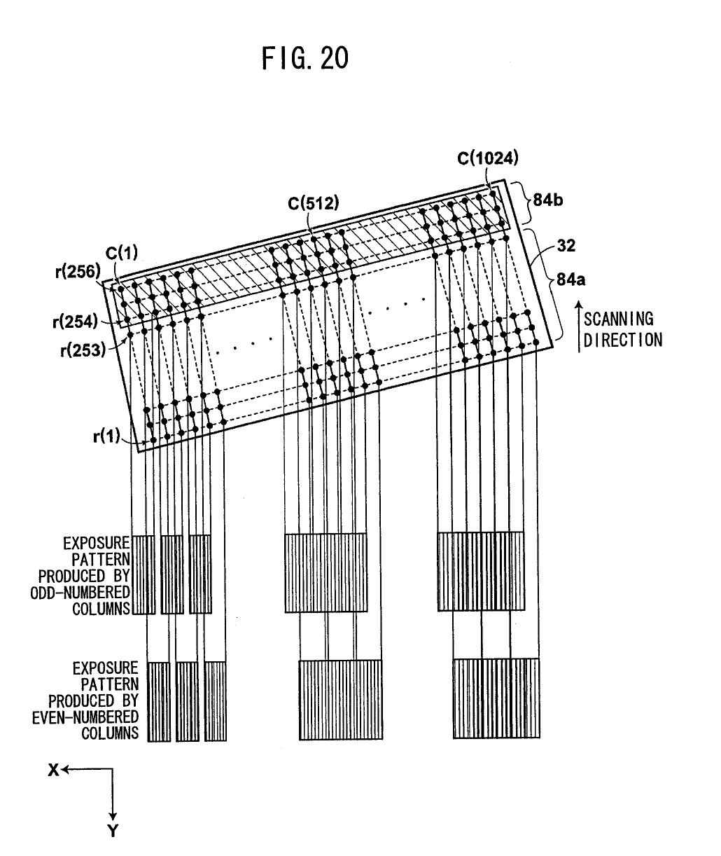

FIG. 20 is a diagram showing the manner in which only those actual micromirrors 58 of the used region 84a are activated, in order to improve irregularities produced on the exposure surface shown in FIG. 17. In this example, T 253 is derived as the natural number T, and the micromirrors from the first row to the 253th row are activated for the main exposure mode.

According to the present embodiment, since the actual tilt angle θ′ is measured using the 512th light spot column as a representative light spot column, and the micromirrors 58 within the used region 84a are selected according to equation (10) based on the actual tilt angle θ′, as shown in FIG. 20, exposure redundancy and exposure insufficiency in the junctions between the pixel columns are substantially fully eliminated in the vicinity of the 512th light spot column, thus making it possible to perform a nearly ideal uniform double exposure process.

In a left region (near c(1)), as shown in FIG. 20, the tilt angle of light spot columns on the exposure surface is smaller than the tilt angle in the central region thereof. Therefore, upon exposure using the micromirrors 58 selected based on the actual tilt angle θ′ measured with respect to the central light spot column c(512), as shown in FIG. 20, insufficient-exposure regions are produced slightly in the junctions between the pixel columns, in the exposed pattern produced by odd-numbered columns of the micromirrors 58, as well as in the exposed pattern produced by even-numbered columns of the micromirrors 58. Within the actual exposed pattern, which is provided by superimposing the exposed patterns produced by the odd-numbered columns and the even-numbered columns of the micromirrors 58, however, such insufficient-exposure regions are mutually interpolated, so that the effect of angle distortion can be made uniform owing to the compensation produced according to the double exposure process.

Further, in a righthand region (near c(1024)), as shown in FIG. 20, the tilt angle of light spot columns on the exposure surface is greater than the tilt angle in the central region thereof. Therefore, upon exposure using the micromirrors 58 selected based on the actual tilt angle θ′ measured with respect to the central light spot column c(512), as shown in FIG. 20, redundant-exposure regions are produced slightly in the junctions between the pixel columns. In the actual exposed pattern, which is provided by superimposing the exposed patterns produced by odd-numbered columns and the even-numbered columns of the micromirrors 58, however, density irregularities due to regions where the remaining exposure is redundant are made uniform and become less outstanding, owing to the compensation produced according to the double exposure process.

With the exposure apparatus 10 according to the present embodiment, as described above, a used region 84a is selected from among a portion of the DMD 36, and a double exposure process is performed in order to reduce resolution and density irregularities resulting from undulations in the photosensitive medium 12, optical system failures of the scanner 24, pixel defects of the micromirrors 58, mount angle errors of the exposure heads 30, and pattern distortions, entirely over the exposure areas 32 of the exposure heads 30.

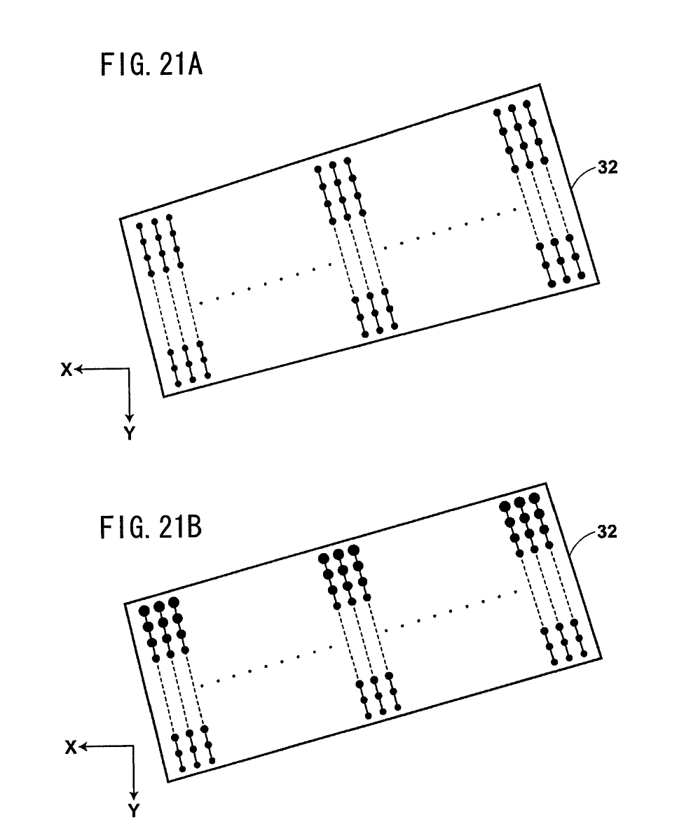

There are various types of pattern distributions, which can be produced on the exposure surface, other than the angle distortion described above. As an example, FIG. 21A shows a magnification distortion caused when light beams from the micromirrors 58 making up the DMD 36 reach the exposure area 32 on the exposure surface at different magnification ratios. As another example, FIG. 21B shows a beam diameter distortion caused when light beams from the micromirrors 58 making up the DMD 36 reach the exposure area 32 on the exposure surface at different beam diameters. Such magnification and beam diameter distortions are caused mainly as a result of various aberrations and misalignments in the optical system, between the DMD 36 and the exposure surface. Still another example is an amount-of-light distortion caused when light beams from the micromirrors 58 making up the DMD 36 reach the exposure area 32 on the exposure surface while exhibiting different amounts of light. The amount-of-light distortion is caused as a result of various aberrations and misalignments, positional dependency of the transmittances of optical elements (e.g., lenses 52, 54 shown in FIGS. 5A and 5B, each comprising a single lens) between the DMD 36 and the exposure surface, as well as amount-of-light irregularities in the DMD 36 itself. With the exposure apparatus 10 according to the above embodiment, however, the remaining elements of these kinds of pattern distortions can be made uniform owing to the compensation performed according to the double exposure process, after the micromirrors 58 of the used region 84a that are actually used for the main exposure mode have been selected, similar to the remaining elements of the angle distortions as described above. Therefore, the exposure apparatus 10 according to the above embodiment is capable of reducing resolution and density irregularities, which occur due to pattern distortions other than angle distortion, entirely over the exposure areas 32 of the exposure heads 30.

The exposure apparatus 10 according to the above embodiment has been described in detail above. However, the foregoing description is provided by way of example only, and various changes may be made to the illustrated embodiment without departing from the scope of the present invention.

For example, in the above embodiment, one light spot column projected onto the exposure surface is selected as a representative light spot, whereby an angle formed between the representative light spot and the scanning direction is selected as the actual tilt angle θ′. However, individual actual tilt angles between the directions of a plurality of light spot columns of the usable micromirrors, projected onto the exposure surface, and the scanning direction may be measured, wherein a central value, an average value, a maximum value, or a minimum value of the individual actual tilt angles may be used as the actual tilt angle θ′, after which the micromirrors 58, which actually are used for the main exposure mode, may be selected according to equation (10), etc. If a central value or an average value of the individual actual tilt angles is used as the actual tilt angle θ′, then a main exposure mode may be realized which exhibits good balance between redundant-exposure regions and insufficient-exposure regions. For example, the main exposure mode may be carried out such that the sum of the redundant-exposure regions and the insufficient-exposure regions is minimized, and in which the number of light spots in the redundant-exposure regions and the number of light spots in the insufficient-exposure regions are made equal to each other. If a maximum value of the individual actual tilt angles is used as the actual tilt angle θ′, then a main exposure mode may be realized in which greater importance is given to elimination of redundant-exposure regions, and wherein the main exposure mode is carried out such that insufficient-exposure regions are minimized and regions with recording redundancy are not produced. If a minimum value of the individual actual tilt angles is used as the actual tilt angle θ′, then a main exposure mode may be realized in which greater importance is given to elimination of the insufficient-exposure regions, and wherein the main exposure mode is carried out such that the redundant-exposure regions are minimized and regions with recording insufficiency are not produced.

According to the above embodiment, furthermore, the angle formed between the direction of the representative light spot column and the scanning direction is identified as the actual tilt angle θ′, based on positions of at least two light spots within the representative light spot column. However, the angle need not necessarily be identified based only on the positions of at least two light spots within the representative light spot column. For example, an angle determined from the position of one or more plural light spots within the representative light spot column, and the positions of one or more plural light spots in a light spot column near to the representative light spot column, may be identified as the actual tilt angle θ′. Specifically, the position of a single light point within the representative light spot column, and the position of one or more plural light spots in a nearby light spot column, extending linearly along the light spot and the scanning direction, may be detected, such that the actual tilt angle θ′ is determined from such positional information. Alternatively, an angle, which is determined based on the positions of at least two light points (e.g., two light spots disposed across the representative light spot column) in light spot columns near to the representative light spot column, may be identified as the actual tilt angle θ′.

In the above embodiment, a set of slits 28 and single-cell light detectors 80 are used as the means for detecting the position of the light spot on the exposure surface. However, the means for detecting the position of the light spot on the exposure surface is not limited to the set of slits 28 and the single-cell light detectors 80, but may also be a two-dimensional detector, for example.

In the above embodiment, the actual tilt angle θ′ is determined from the position of the optical spot, as detected by the set of slits 28 and the single-cell light detectors 80, and the used region 84a is determined based on the actual tilt angle θ′. However, the used region 84a may be determined without deriving the actual tilt angle θ′. Furthermore, a mode of operation, in which a reference exposure mode is performed using all of the micromirrors 58 making up the DMD 36, and in which the operator manually specifies the micromirrors 58 for the used region 84a by visually confirming resolution and density irregularities in the reference exposure mode, may also be included within the scope of the present invention.

According to a modification of the above embodiment, a reference exposure mode may be performed using only those micromirrors 58 that make up every other (N−1) pixel column from among the micromirrors 58 of the used region 84a, or only those micromirrors 58 making up a group of mutually adjacent pixel rows corresponding to 1/N of all the pixel rows, whereby micromirrors 58 that will not be used for the main exposure mode may be identified from among the micromirrors 58 used for the reference exposure mode.

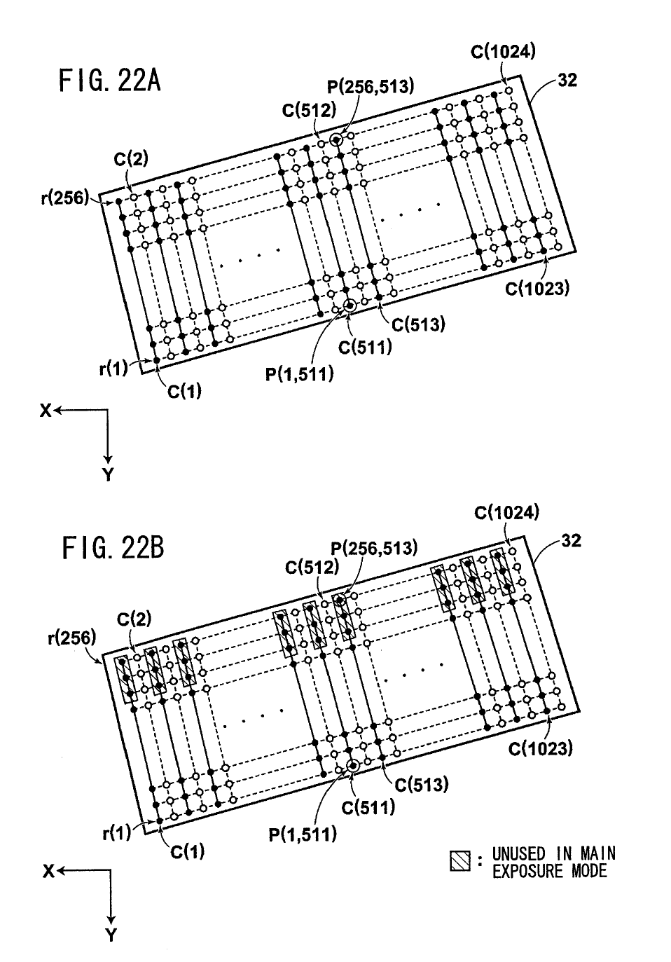

FIGS. 22A and 22B are diagrams showing an example in which the reference exposure mode is carried out using only those micromirrors 58 that make up every other (N−1) pixel column. In this example, the main exposure mode is performed according to a double exposure process, and hence N=2. First, the reference exposure mode is carried out, while using only those micromirrors 58 corresponding to odd-numbered light spot columns as indicated by the solid lines, whereupon the results of the reference exposure mode are sampled and output. The operator visually confirms resolution and density irregularities, and estimates the actual tilt angle on the output results of the reference exposure mode, for thereby specifying the micromirrors 58 which are to be used for the main exposure mode, in order to perform the main exposure mode with minimized resolution and density irregularities. For example, micromirrors 58, other than those corresponding to the light spot columns covered with diagonal lines in FIG. 22B, can be specified as the micromirrors 58 that are actually used for the main exposure mode, from among the micromirrors 58 of the odd-numbered pixel columns. With respect to the even-numbered pixel columns, similarly, the reference exposure mode may be performed in order to specify the micromirrors 58 that are to be used for the main exposure mode, or a pattern identical to the pattern for the odd-numbered pixel columns may be applied. By thus specifying the micromirrors 58 to be used for the main exposure mode, the main exposure mode using micromirrors of both odd-numbered and even-numbered pixel columns can be performed according to a near ideal double exposure process. Results of the reference exposure mode may also be mechanically analyzed, rather than being visually analyzed by the operator.

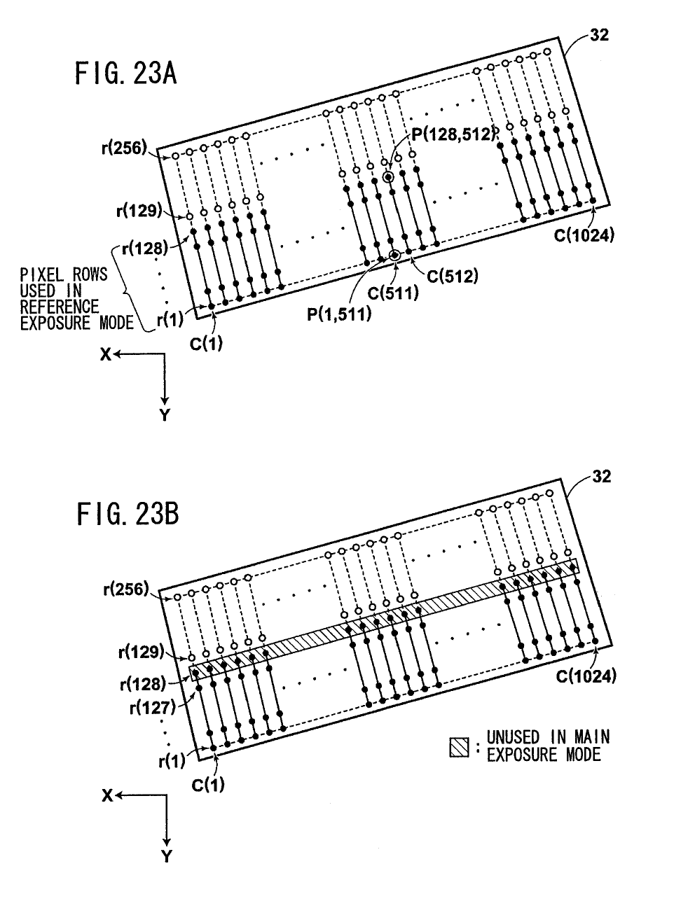

FIGS. 23A and 23B are diagrams showing an example in which a reference exposure mode is carried out using only those micromirrors 58 making up a group of mutually adjacent pixel rows, corresponding to 1/N of the total number of all pixel rows. In this example, the main exposure mode is performed according to a double exposure process, and hence N=2. First, the reference exposure mode is carried out, while using only those micromirrors 58 corresponding to light spots in the first through 128th (=256/2) rows as indicated by the solid lines, whereupon the results of the reference exposure mode are sampled and output. The operator visually confirms resolution and density irregularities, and estimates the actual tilt angle on the output results of the reference exposure mode, for thereby specifying the micromirrors 58 which are to be used for the main exposure mode, in order to perform the main exposure mode with minimized resolution and density irregularities. For example, micromirrors 58, other than those corresponding to the light spot columns covered with diagonal lines in FIG. 23B, can be specified as the micromirrors 58 that are actually used for the main exposure mode, from among the micromirrors 58 in the first through 128th rows.

With respect to micromirrors 58 in the 129th through 256th rows, a reference exposure mode may similarly be performed in order to specify micromirrors 58 to be used for the main exposure mode, or a pattern identical to the pattern for the micromirrors 58 in the first through 128th rows may be applied. By thus specifying the micromirrors 58 to be used for the main exposure mode, the main exposure mode can be performed according to a near ideal double exposure process. Results of the reference exposure mode may also be mechanically analyzed, rather than being visually analyzed by the operator.

Operations for carrying out the main exposure mode, after the used region 84a of the micromirrors 58 making up the DMD 36 has been set as described above, shall be described below with reference to the block diagram shown in FIG. 10.

First, mask data for selecting and actuating the micromirrors 58 of the used region 84a for exposure from among the micromirrors 58 making up the DMD 36 are set in the mask data setting unit 78.

Then, the photosensitive medium 12 is moved together with the movable stage 14 toward the scanner 24. The distance up to the photosensitive medium 12 at each position in the Y direction is detected by the sensors 26, and then is set in the focus position adjuster 82.

When the slits 28 defined in the movable stage 14 reach a position beneath the scanner 24, the scanner 24 is energized to apply the laser beams B to the slits 28, and laser beams B that have passed through the slits 28 are detected by the light detectors 80. The actual tilt angle θ′ is calculated, whereupon the mask data set in the mask data setting unit 78 are corrected.

From the corrected mask data, the mask data setting unit 78 calculates the number of micromirrors 58 to be used during the main exposure mode, and sets a resetting time depending on the number of micromirrors 58, in the resetting time setting unit 76.

Following completion of the above preparatory process, the movable stage 14 is moved toward the sensors 26, and the scanner 24 carries out the main exposure mode. The DMD modulator 74 keeps the micromirrors 58 of the unused region 84b turned off at all times according to mask data supplied from the mask data setting unit 78, and modulates the micromirrors 58 of the used region 84a, which are used during the main exposure mode, based on image data supplied from the image data memory 72. As a result, the laser beams B modulated according to the image date are applied from the DMDs 36 of the exposure heads 30 to the photosensitive medium 12, in order to record an image thereon by way of exposure.

During this time, the focus position adjuster 82 energizes the piezoelectric device 55 depending on the scanned position where the photosensitive medium 12 is scanned by the laser beams B, so as to adjust the positional relationship of the wedge-shaped prisms 53a, 53b, for thereby controlling the optical path length of the laser beams B. Therefore, laser beams B are focused on the photosensitive medium 12 at all times irrespective of the scanned position, thus recording the image highly accurately by way of exposure.

When recording of the image in exposure areas 32 by the DMDs 36 has finished, the image data supplied to the DMD modulator 74 are immediately reset in accordance with the resetting time set in the resetting time setting unit 76. Then, image data for subsequent exposure areas 32 are supplied from the image data memory 72 to the DMD modulator 74, whereupon the process for recording an image on the photosensitive medium 12 is continued.

In this case, the resetting time is set according to the number of micromirrors 58 that are used for exposure. The time required for the DMDs 36 to guide the laser beams B to the photosensitive medium 12 can be set to an appropriate time. Consequently, the pixels 90 are prevented from being recorded in an elongated manner in the direction (Y direction) in which the photosensitive medium 12 is moved. Further, the edge of the image in the moving direction is prevented from sagging.

The above embodiment and modifications thereof have been described with respect to a main exposure mode, which is carried out according to a double exposure process. However, the exposure process is not limited to a double exposure process, but may be a multiple exposure process, which is at least a double exposure process. In particular, a multiple exposure process, ranging from a triple exposure process to a septuple exposure process, can similarly achieve high resolution and a favorably balanced reduction of resolution and density irregularities.

The exposure apparatus according to the above embodiment, as well as the modifications thereof, should preferably incorporate a mechanism therein for converting image data, such that the dimensions of a certain portion of a two-dimensional pattern represented by the image data are the same as the dimensions of a corresponding portion, which can be realized by the employed pixels that are selected. By thus converting the image data, a highly defined pattern, in accordance with a desired two-dimensional pattern, can be formed on the exposure surface.

The exposure apparatus according to the above embodiment and the modifications thereof employ DMDs for modulating light beams from the light source, thereby defining respective pixels as a pixel array. However, the pixel array is not limited to DMDs, but may be a light modulator device, such as a liquid crystal array or the like, or a light source array (e.g., an LED array, an organic EL array, or the like), rather than DMDs.

The exposure apparatus according to the above embodiment, and the modifications thereof, may be operated to perform continuous exposure while moving the exposure heads at all times, or alternatively, may be operated to perform exposure by moving the exposure heads in a stepwise manner while holding the exposure heads at rest in positions at which the exposure heads have been moved.

The present invention is not limited to an exposure apparatus and exposure methods therefor, but also may be applicable to any apparatus and method, insofar as they are recording apparatus and recording methods for recording a recording surface, according to an N-multiple exposure process (N being a natural number of 2 or more) to thereby form a two-dimensional pattern represented by image data on the recording surface. For example, the present invention may be applied to an ink jet printer or to an ink-jet printing method.

Specifically, the ink jet recording heads of a general ink jet printer have nozzles for expelling ink droplets in a nozzle surface, which faces a recording medium (e.g., a sheet of recording paper or an OHP sheet). Some ink jet printers have a head formed as a grid-like array of nozzles, wherein the head is inclined to the scanning direction in order to record an image according to a multiple recording process. In an ink jet printer with such a two-dimensional nozzle array, pattern distortions may be present because the actual tilt angle of the head may differ from an ideal tilt angle, and the nozzles themselves may suffer from layout errors. When the present invention is applied to such an ink jet printer, as many nozzles as possible, so as to minimize the effects of a head mount angle error and pattern distortions, can be specified as nozzles which are actually used, such that the effects of any remaining head mount angle error and remaining pattern distortions can be made uniform by compensation according to the multiple recording process, thereby reducing resolution and density irregularities developed within the recorded image.

An embodiment and modifications of the present invention have been described in detail above. However, the present embodiment and modifications thereof are by way of illustrative example only. The technical scope of the present invention should be defined only by the scope of the patent claims.

1. A recording apparatus for relatively moving a recording head having a plurality of recording elements arranged in a two-dimensional array in a predetermined scanning direction over a recording surface, and for controlling said recording elements according to recording data to record an image on the recording surface, comprising:
recording element control means for controlling said recording elements within a partial element region set to a predetermined width on said recording head with respect to said scanning direction, wherein said array of the recording elements extends in a direction at a preset tilt angle to said scanning direction, for recording an image on said recording surface according to a multiple recording process using said recording elements within said partial element region.

2. A recording apparatus according to claim 1, further comprising mask data setting means for setting mask data, for keeping recording elements which do not contribute to recording the image turned off, wherein said recording element control means controls said recording elements which do not contribute to recording the image so as to be turned off using said mask data, and controls said recording elements within said partial element region according to said recording data.

3. A recording apparatus according to claim 1, wherein said recording element control means sets a resetting time for resetting said recording data for controlling said recording elements according to the number of said recording elements within said partial element region.

4. A recording apparatus for relatively moving a recording head having a plurality of recording elements arranged in a two-dimensional array in a predetermined scanning direction over a recording surface, and for controlling said recording elements according to recording data to record an image on the recording surface, comprising:
recording element control means for setting a resetting time for resetting said recording data according to the number of recording elements within a partial element region of said recording head, and controlling said recording elements within said partial element region according to said recording data, wherein said array of recording elements extends in a direction at a preset tilt angle to said scanning direction, for recording an image on said recording surface according to a multiple recording process using said recording elements within said partial element region.

5. A recording apparatus according to claim 1, wherein the number of said recording elements within said partial element region is set to one-half or less than the total number of said recording elements making up said recording head.

6. A recording apparatus according to claim 1, wherein said recording head comprises an optical system for guiding a light beam toward said recording surface, said partial element region being set within a central portion of said recording head, around an optical axis of said optical system.

7. A recording method for relatively moving a recording head having a plurality of recording elements arranged in a two-dimensional array in a predetermined scanning direction over a recording surface, and for controlling said recording elements according to recording data to record an image on the recording surface, comprising the step of
controlling said recording elements within a partial element region set to a predetermined width on said recording head with respect to said scanning direction, according to said recording data, for recording an image on said recording surface according to a multiple recording process using said recording elements within said partial element region.

8. A recording method according to claim 7, wherein recording elements which do not contribute to recording the image are controlled so as to be turned off, and said recording elements within said partial element region are controlled according to said recording data.

9. A recording method according to claim 7, wherein a resetting time for resetting said recording data for controlling said recording elements is set according to the number of said recording elements within said partial element region.

10. A recording method for relatively moving a recording head having a plurality of recording elements arranged in a two-dimensional array in a predetermined scanning direction over a recording surface, and for controlling said recording elements according to recording data to record an image on the recording surface, comprising the steps of
setting a resetting time for resetting said recording data according to the number of recording elements within a partial element region of said recording head, and controlling said recording elements within said partial element region according to said recording data, for recording an image on said recording surface according to a multiple recording process using said recording elements within said partial element region.

11. A recording method according to claim 7, wherein the number of said recording elements within said partial element region is set to one-half or less than the total number of said recording elements making up said recording head.

12. A recording method according to claim 7, wherein said partial element region is set within a central portion of said recording head, around an optical axis of an optical system included in said recording head for guiding a light beam toward said recording surface.
